(19) United States
(12) Patent Application Publication
(10) Pub. No.: US 2012/0062506 A1
(43) Pub. Date: Mar. 15, 2012

(54) CAPACITIVE TOUCH SCREEN

(75) Inventors: Kyoung Soo Chae, Seoul (KR); Hee Bum Lee, Gyunggi-do (KR); Yong Soo Oh, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/980,655

(22) Filed: Dec. 29, 2010

(30) Foreign Application Priority Data
Sep. 14, 2010 (KR) 1020100089914

(51) Int. Cl. G06F 3/045

(52) U.S. Cl. 345/174

(57) ABSTRACT

Disclosed herein is a capacitive touch screen. The capacitive touch screen is formed with a first type of electrode patterns formed in plural so as to prevent electrode wirings from being formed in a region through which images pass and a second type of electrode patterns having unique coordinate information so as to improve touch sensitivity of an outside region.

### CROSS REFERENCE TO RELATED APPLICATION

This application claims the benefit of Korean Patent Application No. 10-2010-0089914, filed on Sep. 14, 2010, entitled “Capacitive Touch Screen”, which is hereby incorporated by reference in its entirety into this application.

### BACKGROUND OF THE INVENTION

1. Technical Field

The present invention relates to a capacitive touch screen.

2. Description of the Related Art

With the development of a mobile communication technology, user terminals such as cellular phones, PDAs, and navigations can serve as a display unit that simply displays character information as well as a unit for providing various and complex multi-media such as audio, moving picture, radio internet web browser, etc. Due to a recent demand for a larger display screen within a terminal having a limited size, a display scheme adopting a touch screen has been more in the limelight. The touch screen integrates a screen and coordinate input units, thereby making it possible to save a space as compared to a key input scheme according to the prior art.

A type of current mainly used touch screen is largely classified into two schemes.

First, a resistive touch screen has a shape in which an upper substrate formed with an upper resistive film and a lower substrate formed with a lower resistive film are spaced from each other by a spacer and are disposed to be contact each other by external pressure. When an upper substrate formed with an upper electrode film is pressed by an input unit such as fingers, pens or the like, the upper/lower electrode films are conducted and a change in voltage according to a change in resistance value of the positions is recognized by a controller, such that the touched coordinates are recognized.

A capacitive touch screen has a structure in which an upper substrate formed with a first electrode pattern having a first directionality and a lower substrate formed with a second electrode pattern having a second directionality are spaced apart from each other and an insulator is inserted therebetween in order to prevent the first electrode pattern from contacting the second electrode pattern. In addition, the upper substrate and the lower substrate are formed with an electrode wirings connected to the electrode patterns. The electrode wiring transfers the change in capacitance generated in the first electrode pattern and the second electrode pattern according to the touch of the input unit with the touch screen to a controller.

Such a two-layered capacitive touch screen separately configures the upper substrate and the lower substrate to form the electrode patterns and the electrode wirings, and a separate insulator is required to isolate the electrode patterns formed on the upper substrate and the lower substrate from each other. As a result, there is a problem in that the configuration of the touch screen becomes complicated.

Therefore, a research into a single-layer capacitive touch screen has been conducted. However, the single-layer capacitive touch screen according to the prior art has a problem in that touch sensitivity is deteriorated in an outside region. In order to solve the problem, a touch screen in a discrete position sensing scheme having a coordinate value for each electrode has been developed. However, in the touch screen in a discrete position sensing scheme, a great number of electrode wirings are required and the electrode wirings are disposed in a region through which images pass, such that visibility is degraded.

### SUMMARY OF THE INVENTION

The present invention has been made in an effort to provide a capacitive touch screen formed with a first type of electrode patterns formed in plural so as to prevent electrode wirings from being formed in a region through which images pass and a second type of electrode patterns having unique coordinate information so as to improve touch sensitivity of an outside region.

A capacitive touch screen according to a preferred embodiment of the present invention includes: a first electrode pattern having a width becoming narrow in a longitudinal direction thereof along a first axis direction; a second electrode pattern formed adjacent to the first electrode pattern and having a width becoming narrow in a longitudinal direction thereof along a reverse direction to the first axis direction; a base member on which the pair of first electrode pattern and the second electrode pattern are formed in plural in a second axis direction; a plurality of third electrode patterns formed on the base member similar to the first electrode pattern and the second electrode pattern but formed in outside regions of the first electrode pattern and the second electrode pattern in the first axis direction; and a plurality of electrode wirings formed on the base member and connected to the first electrode pattern, the second electrode pattern, and the third electrode patterns. The first electrode pattern and the second electrode pattern may have a right triangular shape.

The third electrode pattern may have a rectangular shape or a square shape.

The first electrode pattern, the second electrode pattern, and the third electrode pattern may be made of a conductive polymer, and the electrode wiring may be made of silver paste.

The capacitive touch screen may further include a window bonded to an upper side of the base member and covering the first electrode pattern, the second electrode pattern, the third electrode patterns, and the electrode wirings.

### BRIEF DESCRIPTION OF THE DRAWINGS

FIG. 1 is a plan view schematically showing a capacitive touch screen according to the present invention;

FIG. 2 is a cross-sectional view of the capacitive touch screen of FIG. 1;

FIGS. 3 and 4 are diagrams for explaining a method of detecting coordinates of a capacitive touch screen according to the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

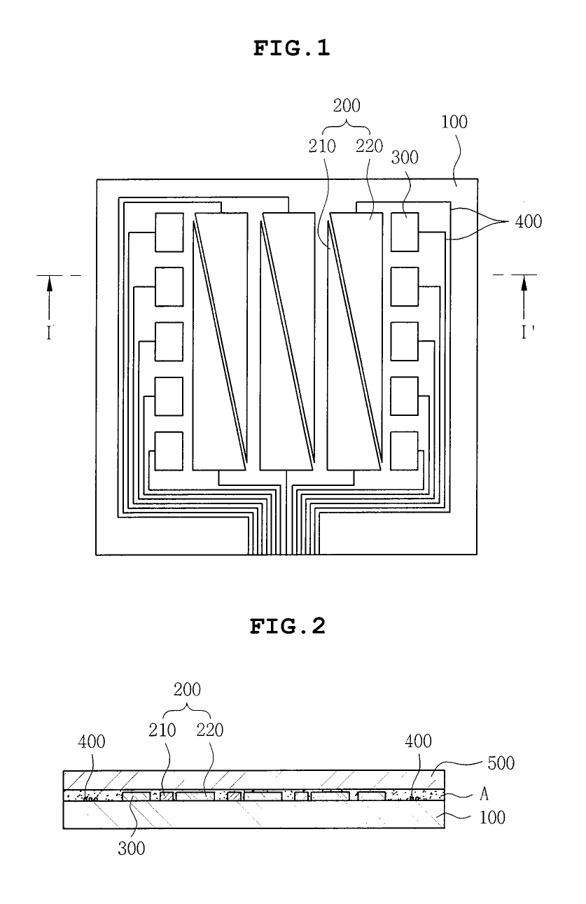

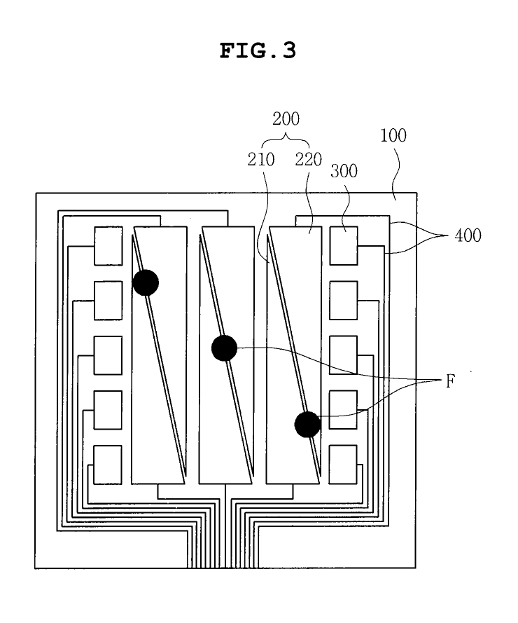

FIG. 1 is a plan view schematically showing a capacitive touch screen according to the present invention, and FIG. 2 is a cross-sectional view of the capacitive touch screen of FIG. 1. Hereinafter, a capacitive touch screen (hereinafter, referred to as a touch screen) according to the present embodiment will be described with reference to these figures.

The touch screen according to the present invention, which is a single-layer capacitive touch screen, is formed with a first type of electrode patterns 200 and a second type of electrode patterns 300 formed on one surface of the base member 100, wherein the second type electrode patterns 300 are formed on the outer side of the first type of electrode patterns 200 to improve touch sensitivity of the outside region.

As the base member 100 on which the electrode patterns 200 and 300 and electrode wirings 400 are formed, a glass substrate, a film substrate, a fiber substrate, a paper substrate, and so on, which are a transparent member, may be used. Among those, the film substrate may be made of polyethyleneterephthalate (PET), polymethylmetacrylate (PMMA), polypropylene (PP), polyethylene (PE), polyethylenenaphthalenedicarboxylate (PEN), polycarbonate (PC), polyethersulfone (PES), polyimide (PI), polyvinylalcohol (PVA), cyclic olefin copolymer (COC), styrene polymer, etc. but is not particularly limited thereto. The material of the base member 100 may be selected according to the kind or purpose of the terminal to which the touch screen is applied.

Next, the electrode patterns 200 and 300 may use a transparent conductive material such as indium tin oxide, regardless of the type thereof. The electrode patterns 200 and 300 may be made of a conductive material by known schemes, such as a gravure printing scheme, an inkjet printing scheme, a photolithography scheme, and the like.

In this case, the electrode pattern 200 may be made of a conductive polymer. The conductive polymer may include an organic compound, such as polythiophene, polypyrrole, polyaniline, polyacetylene, polyphenylene, or the like. In particular, among the polythiophene, poly-3,4-ethylenedioxythiophene/polystyrenesulfonate (PEDOT/PSS) compound is most preferable and at least one of the organic compounds may be mixed. The conductive polymer has advantages in saving a manufacturing cost simultaneously with having a sheet resistance equivalent to ITO. In addition, the conductive polymer has good flexibility, such that it may be applied to a flexible display.

The first type of electrode pattern 200 is configured of a pair of electrode patterns 210 and 220. First, the first electrode pattern 210 has a shape in which a width thereof becomes narrow in a longitudinal direction along a first axis direction. The first electrode pattern 210 is lengthened in a Y-axis direction in FIG. 1, such that a first axis direction will be described as a Y-axis direction and a second axis direction will be described as an X-axis direction. In addition, when the first electrode pattern is lengthened in the X-axis direction, the first axis direction becomes an X-axis direction.

A width of the first electrode pattern 210 becomes narrow along an upper side direction of the Y-axis, such that a width of the lower side of the first electrode pattern 210 is formed to be wider than that of the upper side thereof. In addition, a length of the first electrode pattern 210 is determined to correspond to a length of the region through which images pass.

The second electrode pattern 220 is formed to be adjacent to the first electrode pattern 210 and has a shape in which a width of thereof becomes narrow in a longitudinal direction along a reverse direction to the first axis direction. Therefore, a width of the upper side of the second electrode pattern 220 is formed to be wider than that of the lower side thereof.

However, the first electrode pattern 210 and the second electrode pattern 220 are not limited to such a shape, but a width of the first electrode pattern may be formed to become narrow along a lower side direction of the Y-axis and a width of the second electrode pattern may be formed to become narrow along an upper side direction of the Y-axis. In this case, another first type of electrode pattern having a mirror shape with the first type of electrode pattern 200 shown in FIG. 1 is formed.

At this time, both the first electrode pattern 210 and the second electrode pattern 220 may have a right triangular shape. Since the first electrode pattern 210 and the second electrode pattern 220 are disposed adjacent to each other to form a rectangular shape, the electrode pattern can be densely formed to improve touch sensitivity.

In addition, although the first electrode pattern 210 and the second electrode pattern 220 have a difficulty in view of patterning their shapes, they may be formed to have a shape in which an oblique side of the right triangle is modified.

The touch screen according to the present invention further includes a second type of electrode patterns 300 different from the first type of electrode patterns 200, wherein the second type of electrode patterns 300 are formed in plural on the base member 100 but in the outside region of the first type of electrode patterns 200 in the first axis direction. The second type of electrode pattern 300 is represented as a third electrode pattern 300 in order to be distinguished from the first electrode pattern 210 and the second electrode pattern 220.

The third electrode pattern 300 may be formed of the same material as that of the first electrode pattern 210 and the second electrode pattern 220.

The first electrode patterns 210, the second electrode patterns 220, and the third electrode patterns 300 are connected to the electrode wirings 400 in order to transfer a change in capacitance generated according to the touch of the input unit with the touch screen to a controller. However, the first type of electrode patterns 200 and the electrode wirings 400 are connected to each other in the second axis direction, such that the third electrode patterns 300 are formed in the first axis direction in order not to interfere them.

The third electrode pattern 300 may have a rectangular shape or a square shape in order to be densely formed in the outside region.

Meanwhile, since the electrode wirings 400 are connected to a controller through a FPC, the plurality of electrode wirings 400 may have one ends collected at one side of the base member 100 in order to facilitate the connection with the FPC.

In addition, the electrode wirings 400 may be made of a metal material having excellent conductivity but may be preferably made of silver (Ag) paste capable of easily manufacturing an electrode wiring in an inkjet printing scheme or the like.

As shown in FIG. 2, the touch screen according to the present invention includes a window 500 disposed on an upper side of the base member 100 and covering the first electrode patterns 210, the second electrode patterns 220, the third electrode patterns 300, and the electrode wirings 400.

The window 500 provides a surface touched by an input unit. The glass substrate (in particular, tempered glass), the film substrate or the like may be used as the window 500.

The window 500 is bonded to the base member 100 using an optical adhesive A such as an OCA. In addition, a covering film (not shown) covering the electrode wirings 400 formed on the base member 100 may be formed in the outside region of the upper surface or lower surface of the window 500. When the electrode wirings 400 are made of metal such as silver paste, the electrode wirings 400 may be recognized from the outside. In order to prevent it, the covering film is provided. For example, the covering film may be formed by printing ink having low brightness such as black ink to the outside region of the window.

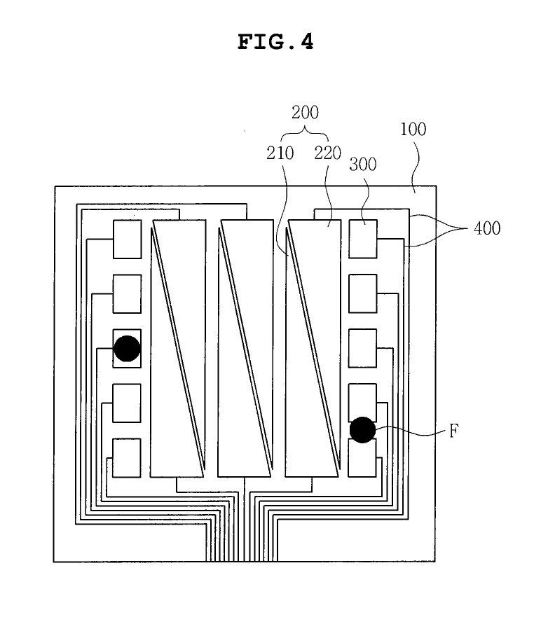

FIGS. 3 and 4 are diagrams for explaining a method of detecting coordinates of a capacitive touch screen according to the present invention. In the touch screen according to the present invention, methods of detecting coordinates of the first type of electrode patterns 200 and the second type of electrode patterns 300 are partially different.

First, the first type of electrode patterns 200 occupying most of the touch screen detect coordinates in a Y-axis direction by comparing changes in capacitance detected from the first electrode patterns 210 and the second electrode patterns 220.

Referring to FIG. 3, in the first type of electrode pattern 200 disposed at the left, a change in capacitance generated from the second electrode pattern 220 is significantly greater than that generated from the first electrode pattern 210. In the first type of electrode pattern 200 disposed at the center, a change in capacitance generated from the second electrode pattern 220 is similar to that generated from the first electrode pattern 210. In the first type of electrode pattern 200 disposed at the right, a change in capacitance is opposite to that of the first type of electrode pattern 200 disposed at the left.

As such, the changes in capacitance generated from the first electrode pattern 210 and the second electrode pattern 220 are digitized to detect coordinate information in the Y-axis direction.

On the contrary, coordinate information in the X-axis direction is calculated by determining from which one of the first type of electrode patterns 200 disposed at the left, center, and right changes in capacitance are shown. If the changes in capacitance are simultaneously shown from the first type of two electrode patterns 200, the coordinate information in the X-axis direction may be more minutely corrected based on a ratio therebetween.

Meanwhile, if the touch screen is configured of only the first type of electrode patterns 200, the first electrode pattern 210 and the second electrode pattern 200 disposed at the outermost sides do not have other electrode patterns on the left side or the right side thereof; such that it is difficult to accurately calculate coordinate information in the Y-axis direction when the outside region is touched by the input unit F.

Therefore, as shown in FIG. 4, the touch screen according to the present invention disposes the third electrode patterns 300 having unique coordinate information in the outside region of the first type of electrode patterns. As shown in FIG. 4, since the third electrode pattern 300 has an area of the electrode pattern much smaller than that of the first type of electrode pattern 200, a change in capacitance is clearly shown according to the touch of the input unit F, thereby increasing touch sensitivity. In addition, the electrode wirings 400 are each connected to the electrode patterns, such that the change in capacitance directly leads to the coordinate information.

When the two third electrode patterns are touched by the input unit F as shown in the right-bottom of FIG. 4, the coordinate information can be more minutely corrected by comparing the changes in capacitance thereof.

In the capacitive touch screen according to the present invention, the single-layer capacitive touch screen is implemented to have a simple configuration, the electrode wirings are not formed in a region through which images pass to improve visibility, and the material selection of the electrode wirings is not limited.

In addition, the plurality of electrode patterns having unique coordinate information are formed in an outside region, thereby making it possible to improve touch sensitivity in the outside region.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A capacitive touch screen, comprising:
a first electrode pattern having a width becoming narrow in a longitudinal direction thereof along a first axis direction;
a second electrode pattern formed adjacent to the first electrode pattern and having a width becoming narrow in a longitudinal direction thereof along a reverse direction to the first axis direction;
a base member on which a pair of the first electrode pattern and the second electrode pattern are formed in plural in a second axis direction;
a plurality of third electrode patterns formed on the base member similar to the first electrode pattern and the second electrode pattern but formed in outside regions of the first electrode pattern and the second electrode pattern in the first axis direction; and
a plurality of electrode wirings formed on the base member and connected to the first electrode pattern, the second electrode pattern, and the third electrode patterns.

2. The capacitive touch screen as set forth in claim 1, wherein the first electrode pattern and the second electrode pattern have a right triangular shape.

3. The capacitive touch screen as set forth in claim 1, wherein the third electrode pattern has a rectangular shape or a square shape.

4. The capacitive touch screen as set forth in claim 1, wherein the first electrode pattern, the second electrode pattern, and the third electrode pattern are made of a conductive polymer, and the electrode wiring is made of silver paste.

5. The capacitive touch screen as set forth in claim 1, further comprising a window bonded to an upper side of the base member and covering the first electrode pattern, the second electrode pattern, the third electrode patterns, and the electrode wirings.
